(19) United States
(12) Patent Application Publication
(10) Pub. No.: US 2018/0320410 A1
(43) Pub. Date: Nov. 8, 2018

(54) Device for Opening and Locking Doors with Automatic Clutch System

(71) Applicant: Baintex Technologies, S.L., Pobla de Farnals (Valencia) (ES)

(72) Inventors: Antonio Pérez Cortés, Pobla de Farnals (Valencia) (ES); José Miguel Esteve Esteve, Pobla de Farnals (Valencia) (ES); Alberto Sandra Estrella, Pobla de Farnals (Valencia) (ES); Carlos Escriche Izquierdo, Pobla de Farnals (Valencia) (ES); Moisés Asensi Ferrandis, Pobla de Farnals (Valencia) (ES)

(21) Appl. No.: 15/773,711

(22) PCT Filed: Nov. 4, 2016
(86) PCT No.: PCT/ES2016/070786

§ 371 Date: May 4, 2018

(30) Foreign Application Priority Data
Nov. 16, 2015 (ES) P201531659

(51) Int. Cl. E05B 47/00

(52) U.S. Cl. CPC E05B 47/0012; E05B 2047/0084; E05B 2047/0026

(57) ABSTRACT

A door opening and closing device with automatic clutch system, which makes it possible to transmit (engage) or interrupt (disengage) the torque generated by a motor to a shaft coupled to a lock cylinder, and including a knob (1), joined to a rotation shaft (2), joined with a spring rotation washer (3) on the shaft, and where a spring is then located (4) for joining two toothed rotary bushes (5,7) and a guide bearing (6); and where the rotating bushes (5,7) are always meshed by the action of a compression spring (4), and in their resting position, are in contact with the upper wall of the motor housing (12) connected with a gearwheel with torque transmission lugs (8).

### PURPOSE OF THE INVENTION

The purpose of this specification is a device for opening and closing doors, with an automatic clutch system, which makes it possible to transmit (engage) or interrupt (disengage) the torque generated by an electric motor to a shaft coupled to a lock cylinder.

### BACKGROUND FOR THE INVENTION

At present, various systems, devices or electromechanical means of motorizing lock cylinders for doors are known. For example:
Locks with built-in latch bolt automation. These systems are based on the retraction of an electromagnet, which picks up or withdraws the latch bolt. This system has several important problems. One of them is the need to change the whole lock in order to automate a door, with all the problems involved, since there are not many models and due to the need to adapt the interior of the door to this new lock. On the other hand the latch bolt can only travel a short distance, which means that security in the lock is lost, and there is no possibility of automating the slam latch existing in the normal European locks.
Electronic lock-opening systems for the ¼ turn pin model, called “deadbolt” or “American” lock type. These electronic systems are quite developed in the American market. There are various highly sophisticated models such as the “August” model. These systems only work for American lock models, which only have one ¼ turn movement. In which case the manual movement and the movement of the electric motor can coexist simply. The clutch can be disengaged or engaged with a simple toothed gear with a single pushing point for the motor.
Electromechanical systems adaptable to cylinders with a key. These systems use an electronically controlled motor that acts on a key, which is always left on the inside of the door to be automated. The motor's clutch engages or disengages from the cylinder by fitting a cylinder with a key with a double clutch. The main problem with this system is that it can leave the door locked if the internal key is not in its correct position at the end of the maneuver. This exact positioning is complex to achieve, so the probability of preventing the opening of a door from the inside is high. To perform manual maneuvers, the knob must be pressed hard to release it from its anchorage, which also makes manual maneuvering difficult.

In view of these currently existing solutions, the main problem to be solved in this mechanical system is the engaging and disengaging of the electric motor clutch once the maneuver of opening or closing the lock has been completed;

since it is a fundamental condition that both lock-opening maneuvers coexist for security reasons, and it must be possible to open both manually and automatically.

In the same way, even if there is a problem with the motor, or in any part of the electronics, in the opening or closing phase, and the latter stops working; either because it has no power, has broken, etc. It should always be possible to open or close the lock, both from the outside of the door and from the inside. Otherwise the door would be locked, preventing exit or access through the door, a situation that should not occur in any event.

The three examples of systems described above do not meet this condition in one hundred percent of the cases, so their use can lead to high risk situations.

Similarly, the electronic opening system used in the United States is not valid for the European market, since it moves a low security latch bolt, a system that is not marketed in these highly demanding markets in terms of security, where the locks have complex multipoint closure systems, and their cylinders usually give more than one full turn to perform the opening closing maneuver.

### DESCRIPTION OF THE INVENTION

The technical problem solved by the present invention is to achieve a means or device for solving the engaging and disengaging of the electric motor clutch once the lock opening or closing maneuver has been completed. This technical problem is solved by the independent claim that accompanies the present description and which is incorporated herein as a reference. Other particular embodiments of the invention are described in the dependent claims, which are similarly incorporated herein in their entirety as a reference.

As a result of its design, the device presented here will be able to combine the manual maneuvers with the automatic ones made by the electric motor included in it.

In this way, in the event of a breakdown of the mechanism, power failure, etc. the electromechanical part of the device will never block the lock, preventing it from being disabled by preventing its opening or closing, thus providing a basic measure with regard to its security/safety.

The device is designed to become a totally versatile element in terms of use, allowing the opening of any type of European “DIN” cylinder lock, or American “deadbolt” type, with a % turn for closing or opening.

Lastly, the device is also designed to allow infinite turns, both to the right and left, to adapt to any type of maneuver, whatever the brand, model or complexity of the lock controlled by the cylinder.

Throughout the description and the claims the word “comprises” and its variants do not intend to exclude other technical characteristics, additives, components or steps. For experts in the field, other objects, advantages and characteristics of the invention will derive in part from the description and in part from the practice of the invention. The following examples and drawings are provided by way of illustration, and are not intended to restrict the present invention. In addition, the present invention covers all possible combinations of particular and preferred embodiments indicated herein.

### BRIEF DESCRIPTION OF THE FIGURES

A brief description is given below of a series of drawings that help to better understand the invention and that are expressly related to an embodiment of said invention that is presented as a non-limiting example thereof.

FIG. 1. It shows a view of the door opening and closing device with automatic clutch system, that is the purpose of the present invention.

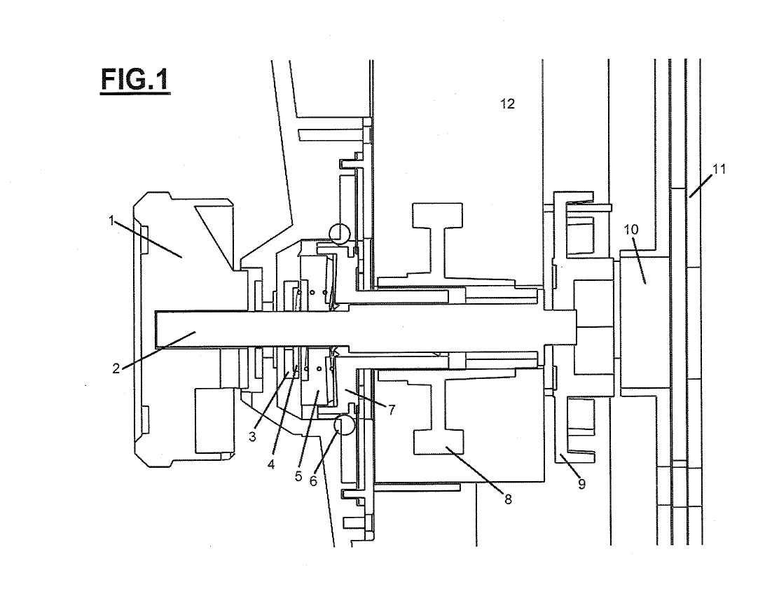

### PREFERRED EMBODIMENT OF THE INVENTION

A preferred embodiment of the invention is shown in the attached FIGURE. More specifically, the door opening and closing device with automatic clutch system, purpose of the present specification, is composed of a knob (1), which makes it possible to operate or maneuver it manually from the inside of the door; and wherein said knob (1) is attached to a rotating shaft (2), which connects the knob (1) to the motor (12) of the lock cylinder.

And where said shaft (2) is joined with a rotating spring washer (3) on the shaft, and where a spring (4) for connecting two rotating toothed bushes (5,7) and a guide bearing (6) is then placed.

The rotating bushes (5, 7) are meshed at all times by the action of a compression spring (4), and can move along the shaft (2). And where said bushes (5,7) in their resting position, are in contact with the upper wall of the motor housing (12) connected to a sprocket with motor torque transmission shafts (8).

The teeth of the bushes (5,7) have a 38° angle of inclination, which allows one tooth to slide easily over the other.

The shaft (2) is integrally connected to the cylinder shaft via a coupling (10), and where, thanks to the hexagonal shape this has on its rear part, it fits into the cavity that the finned crown wheel (9) attached to the shaft (2) has.

Lastly, after the coupling (10) is the housing (11), which will be responsible for housing the entire system, and in a preferred embodiment will be made of a plastic material.

In a practical embodiment of the invention the user will be able to work with two basic maneuvers, one manual and one automatic.

In the case of a manual maneuver, the user can open the door manually both with a key (from the outside of the door) and with the knob, from inside.

In this manual maneuver, the user, on turning the knob or key, causes the shaft attached to these elements to rotate the cylinder shaft directly, which is the one that turns the mechanism of the lock.

This equipment's shaft (2), is attached to the cylinder shaft via the coupler (10), fixed by a captive device to the cylinder shaft, and, in turn, due to the hexagonal shape that this has on its rear part, fits into the cavity of the same shape that the finned crown wheel has (9), which is rigidly attached to the shaft (2) that joins this part with the assembly's knob (1). In this way the user can turn the lock cylinder, both using the knob, and using the key, by turning the cylinder directly.

In this manual maneuver the motor (12) is halted, blocking the gear wheel with torque transmission lugs (8).

Therefore, the geared bush coupling with the motor (7) will mesh with the gear wheel with lugs (8). Therefore, in its normal position (disengaged), it will be in its lowest position, with the lower part of this bush (7) touching the motor housing (12), and maintaining this position as a result of the thrust of the connecting spring of the toothed bushes (5,7).

Such that, when manually rotated, the toothed bush with a vertical movement (5), upon finding the motor coupling bush (7) blocked, begins to slide its teeth over the teeth of the motor coupling gear bushing (7), which will cause the spring (4) connecting both to be compressed, and will therefore allow the shaft (2) to rotate freely.

To do so, the spring (4) connecting both bushes (5,7) rotates jointly with the shaft, to avoid torsion on its thread. To achieve this, the spring (4), on its upper side rests on the rotation washer (3), which always rotates integrally with the shaft (2), since this washer (3) has two straight recesses in its bore, the same size and shape as the shaft (2).

On the bottom side, the spring (4) rests against the toothed bush with free vertical movement (5), which also rotates in solidarity with the shaft (2), on also having a hole through it in the shape of the shaft (2), with both turning in solidarity at all times.

This set of parts has a vertical movement on the shaft (2), which allows one toothed bush to rotate and slide over the other.

In the automatic maneuver, when the motor (12) starts to rotate, the sprocket with motor torque transmission lugs (8) begins to rotate, when these lugs strike the toothed bush coupling with the motor (7), this offers a resistance to the motor, on being meshed with the vertical movement bush (5), with the result that the gear wheel lug (8) begins to slide on the curved side defined in the gear coupling bush (7), forcing it to rise on its rotation shaft. This lifting movement occurs throughout the curve defined in this bush (7), up to a total of 4 mm of elevation, from its equilibrium position. At the maximum point of elevation, this bush (7) is completely joined to the free vertical movement toothed bush (5), with the latter entering into contact with the inner side of the equipment housing (11), with the result that it is no longer possible to disengage both parts (5,7), while the motor (12) is rotating.

This total meshing allows the motor (12) to rotate the shaft (2), and transmitting by means of the finned crown wheel (9) and the coupling (10) that is integral to it, to rotate the shaft of the cylinder. In this way the motor (12) can open the lock, or by turning in the opposite direction, close the lock.

At the moment when the motor stops rotating, it stops pushing the lug of the toothed wheel (8) on the lifting curve of the toothed bush coupling with the motor (7), leaving the latter free. When free, the spring (4) pushes these bushes (5,7) back to their lowest point, thereby disengaging the motor (12) with respect to the rotation shaft (2) and leaving it free, at which time the user will have control over the manual maneuver.

What is claimed is:

1. A device for opening and closing doors with an automatic clutch system comprising:
a knob;
a motor for a lock cylinder;
a motor housing for the motor;
a rotation shaft attached to the knob and which connects the knob to the motor for the lock cylinder;
a washer connected to the rotation shaft;
two rotating toothed bushes arranged around the rotation shaft;
a guide bearing for guiding at least one of the two rotating toothed bushes;
a compression spring arranged around the rotation shaft;
wherein said shaft is connected to the washer for rotating the compression spring arranged around the shaft, and
wherein the spring applies pressure to join the two rotating toothed bushes such that the rotating toothed bushes are always engaged by the action of the compression spring, and in a rest position of the toothed bushes, at least one toothed bush is in contact with an upper wall of the motor housing and connected to a gear wheel with torque transmission lugs.

2. A device in accordance with claim 1,
further comprising a coupling for connecting the shaft integrally with a shaft of the lock cylinder, and
wherein the shaft has a hexagonal shape at a rear end thereof which fits into a cavity of a finned crown wheel which is attached to the shaft.

3. A device in accordance with claim 1, further comprising a housing located after the coupling, responsible for housing the entire system.

4. A device in accordance with claim 1, wherein the toothed bushes each have an inclination angle of 38°, allowing one toothed bush to easily slide over the other toothed bush.

5. A device in accordance with claim 3, wherein the housing is made of a plastic material.
